(19) United States
(12) Patent Application Publication
(10) Pub. No.: US 2004/0060819 A1
(43) Pub. Date: Apr. 1, 2004

(54) Electrodialysis and electrodeposition membrane electrode device

(76) Inventors: Roberto Pizzamiglio, San Felice Segrate (IT); Nicolas Vatista, Lucca (IT)

Correspondence Address: Myers Dawes Andreas & Sherman, 19900 Macarthur Boulevard, Suite 1150, Irvine, CA, 92312, US

(21) Appl. No.: 10/415,240

(22) PCT Filed: Aug. 22, 2002
(86) PCT No.: PCT/IT02/00546

(30) Foreign Application Priority Data
Aug. 28, 2001 (IT) T02001A000836

(51) Int. Cl. G01N 27/26

(52) U.S. Cl. 204/415

(57) ABSTRACT

An electrodeposition and electrodialysis cell (1) having a rigid support structure (8) supporting a semipermeable membrane (9), and a number of attachments (50), each for supporting a respective electrode (7) so as to selectively vary the number and type of electrodes in the cell.

### TECHNICAL FIELD

The present invention relates to an electrodeposition and electrodialysis cell, in particular for painting processes by immersion in a paint bath.

### BACKGROUND ART

As is known, in electrodeposition coating or painting processes, the object to be painted is immersed in a paint bath in a tank containing electrodeposition and electrodialysis cells, which perform the twofold function of generating in the bath the electric field required for electrodeposition of a layer of paint on the object, and of ensuring effective ion removal from the bath to keep its chemical characteristics constant.

Electrodeposition and electrodialysis cells therefore generally comprise a supporting structure, a metal electrode, and a semipermeable membrane, which define a channel in which to circulate a dialysis liquid (electrolyte) inside the cell; and the membrane is fitted to the supporting structure at a given distance from the electrode to separate, in use, the paint bath in the tank from the electrolyte circulating in the cell.

Each cell normally comprises one electrode defined by a hollow tubular body (typical of so-called “tubular cells”) or by a plate (preferred solution of so-called “flat cells”).

In both cases, such cells have the drawback of poor versatility, by each being designed for a specific performance in terms of the electric field generated: any change in the characteristics of the field generated in the electrodeposition bath (intensity, form, distribution, etc.) therefore calls for either replacing the cell with another designed to provide the required characteristics, or using a different number of cells.

### DISCLOSURE OF INVENTION

It is an object of the present invention to provide an electrodeposition and electrodialysis cell designed to eliminate the aforementioned drawbacks of the known state of the art.

According to the present invention, there is provided an electrodeposition and electrodialysis cell comprising a supporting structure; at least one electrode; and a semipermeable membrane surrounding the electrode, at a given distance from the electrode, and defining, together with the supporting structure, a channel in which to circulate a dialysis liquid inside the cell; the cell being characterized by comprising supporting means for supporting a selected number of electrodes, so as to selectively vary the number and type of electrodes in the cell.

Being designed to house a number of electrodes, the cell according to the invention can therefore be fitted and installed with the number of electrodes required for a specific application and performance.

Besides selecting the number of electrodes installed in the cell, the same cell can also be fitted with electrodes of different sizes and/or types to vary the resulting electric field.

In a preferred embodiment, the supporting means comprise a first electrode-holder member carried by the supporting structure and having a number of attachments, each for supporting a respective electrode; and the attachments are associated with respective fastening devices for securing the electrodes releasably to the respective attachments. The cell according to the invention therefore provides for replacing individual worn or deteriorated electrodes quickly and easily, and for replacing each electrode independently of the others.

The fastening devices preferably also provide for orienting each electrode with respect to its longitudinal axis of symmetry. That is, each electrode can be rotated about its longitudinal axis of symmetry to permit homogeneous use, and so prolong the working life, of the electrode. This is particularly significant in that, as is known, the outer surface of the electrode wears gradually but unevenly in use, and undergoes greater wear at preferential areas, depending on the electric field generated in the electrodeposition bath (maximum wear typically occurs at maximum electric field intensity, i.e. normally on the part of electrode facing the object for coating).

Another important aspect of the invention lies in the electrodes being defined by solid bars, preferably straight, circular-section, solid cylindrical bars to safeguard against piercing to which tubular and plate electrodes (both relatively thin) are subject. Moreover, each solid-bar electrode is much lighter than a conventional tubular or plate electrode (performance comparable with that of a tubular or plate electrode, in fact, is achieved using a number of solid-bar electrodes) so that individual electrodes are easier to inspect and replace.

The invention provides for forming both tubular and flat cells: here and hereinafter, “tubular cell” is intended to mean a cell in which the membrane assumes a tubular configuration, i.e. has a closed perimeter; and “flat cell” a cell in which the membrane has an open configuration, and is located along the front of the cell, which may be flat or curved, e.g. parabolic.

### BRIEF DESCRIPTION OF THE DRAWINGS

A non-limiting embodiment of the present invention will be described by way of example with reference to the accompanying drawings, in which:

FIG. 1 shows a schematic side view, with parts shown partly in section and parts removed for clarity, of an electrodeposition and electrodialysis cell in accordance with the invention and installed in a paint tank;

FIGS. 2 and 3 show respective sections along lines II-II and III-III in FIG. 1;

FIG. 4 shows a top plan view, pith parts removed for clarity, of the FIG. 1 cell;

FIG. 5 shows a partial schematic view of a different version of the FIG. I cell;

FIG. 6 shows a schematic side view, with parts shown partly in section and parts removed for clarity, of a further variation of the cell according to the invention;

FIG. 7 shows a section along line VII-VII in FIG. 6;

FIG. 8 shows a schematic section, along a line corresponding to VII-VII in FIG. 6, of a variation of the FIG. 6 cell;

FIGS. 9 and 10 show schematic cross sections of further variations of the cell according to the invention.

### BEST MODE FOR CARRYING OUT THE INVENTION

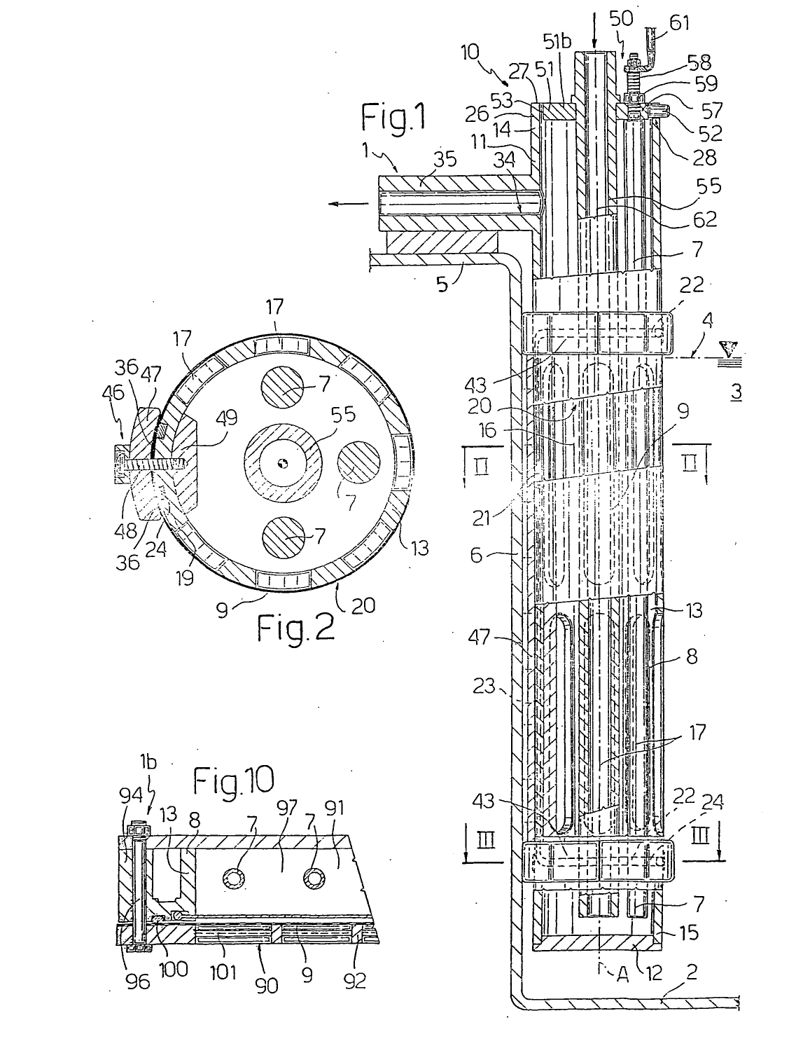

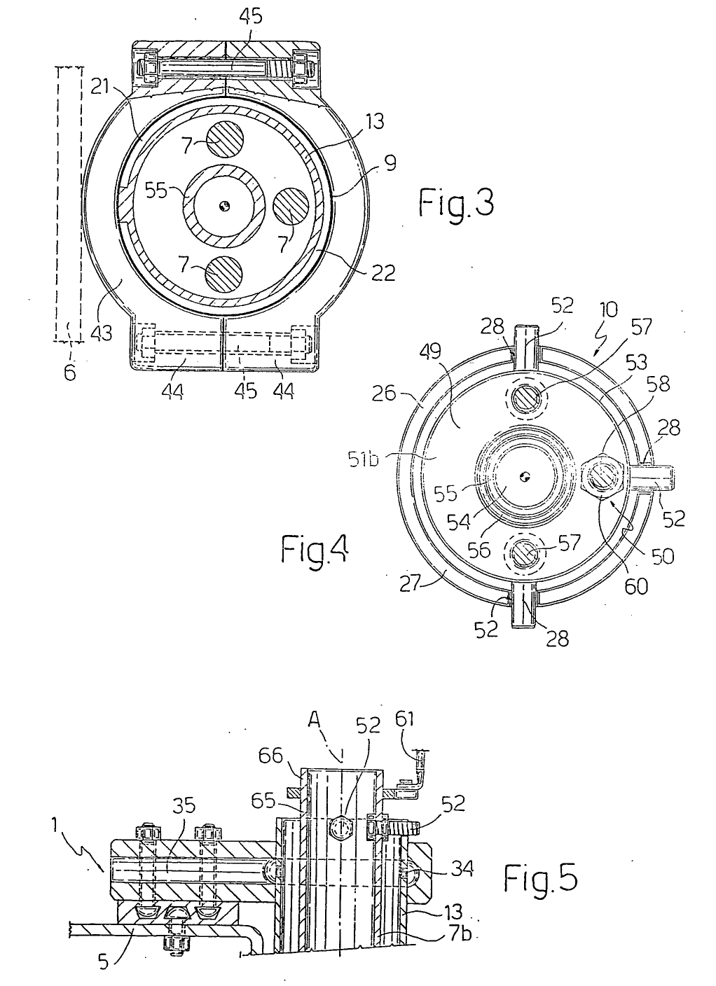

Number 1 in FIGS. 1 to 4 indicates as a whole an electrodeposition and electrodialysis cell installed in a tank 2 containing a paint bath 3 up to a given level defined by a free surface 4. Cell 1 is fixed in known manner to an edge 5 of tank 2, close to a lateral wall 6 of tank 2.

Cell 1 is tubular, has a central axis A, and comprises a number of electrodes 7 defined by circular-section, solid cylindrical bars and arranged about axis A; a supporting structure 8; and a semipermeable membrane 9 surrounding supporting structure 8. Supporting means, indicated as a whole by 10, are provided for supporting a selected number of electrodes 7, so as to selectively vary the number of electrodes in the cell as explained later on.

Supporting structure 8 is a rigid structure comprising a head 11, a bottom cap 12, and a rigid body 13.

Body 13, made for example of rigid polymer material, is a tubular body having two opposite, respectively top and bottom, open axial ends 14, 15; head 11 is defined by an end portion of body 13 at axial end 14; and cap 12 is welded (or fixed in fluidtight manner in any other way) to axial end 15 of body 13.

Body 13 comprises a cylindrical lateral wall 16, in which are formed a number of ample radial windows 17 defining a grille. In a solution which is the object of a co-pending patent application by the present Applicant, a radially outer lateral surface 20 of lateral wall 16 comprises a continuous groove 21 extending along an endless path and comprising two parallel circumferential portions 22, and two substantially parallel straight axial portions 23 connecting and perpendicular to circumferential portions 22.

Groove 21 houses an endless seal 24 made, for example, of deformable elastomeric material, and which, in use, i.e. housed inside groove 21, comprises two eyelets housed in circumferential portions 22 of groove 21, and two straight portions housed in axial portions 23 of groove 21.

At axial end 14, body 13 comprises a cylindrical connecting portion 26 terminating with an annular end edge 27 having three circumferentially spaced connecting seats 28 defined, for example, by respective slots. In the non-limiting example shown, two diametrically opposite connecting seats 28 are provided, with a third connecting seat 28 equidistant the first two. In possible variations not shown, three connecting seats 28 spaced 120° apart, or four connecting seats 28 spaced 90° apart are provided. Both the number and arrangement of seats 28, however, may differ from those indicated herein purely by way of example.

Head 11 comprises radially through holes 34 connected to an outlet fitting 35.

Membrane 9, in itself known, is defined by a substantially rectangular sheet and wound about lateral surface 20 in a continuous tubular configuration; two end portions 36 of membrane 9 are superimposed to cover axial portions 23 of groove 21; and respective opposite axial ends of membrane 9 extend beyond circumferential portions 22 of groove 21.

Two fastening rings 43, defined by respective pairs of half-rings 44 tightened by screws 45, are fitted over circumferential portions 22 of groove 21 to grip, in use, the axial ends of membrane 9 against lateral surface 20 with the interposition of seal 24. A fastening bar 47 extends longitudinally between fastening rings 43 and over axial portions 23 of groove 21 and superimposed portions 36 of membrane 9, and has a number of screws 48 spaced axially apart and inserted, in use, through portions 36 of membrane 9 to engage respective seats formed in a mating member 49 housed inside supporting structure 8, and grip superimposed portions 36 of membrane 9 against lateral surface 20 with the interposition of seal 24.

Supporting means 10 comprise a number of attachments 50 carried by an electrode-holder member 51 and for supporting respective electrodes 7 in respective given positions—in particular, substantially about axis A.

Electrode-holder member 51 comprises a disk-shaped plate 51b fitted releasably to connecting portion 26 of supporting structure 8 by inserting respective fastening members 52 inside connecting seats 28. Fastening members 52 project radially from a lateral edge 53 of plate 51b, are defined, in the example shown, by respective threaded rods screwed inside corresponding nut screw seats formed in lateral edge 53, and are located to correspond with and for axial insertion inside connecting seats 28 to support plate 51b.

Plate 51b has a central hole 54 for housing a tube 55 made, for example, of PVC or other suitable polymer material, and supported on plate 51b by means of a radially outer collar 56 cooperating with a peripheral edge of central hole 54.

When plate 51b is fitted to connecting portion 26, plate 51b and tube 55 are coaxial with body 13 along axis A.

Attachments 50 are defined by respective seats formed through plate 51b and parallel to central hole 54, and through which are inserted respective axial ends 58 of electrodes 7. Seats 57 are arranged substantially about central hole 54 (and therefore about axis A): in the non-limiting example shown in FIGS. 1-4, three seats 57 arranged in an arc and spaced 90° apart are provided, though both the number and arrangement of seats 57 in plate 51b may be other than as shown herein by way of example.

Each attachment 50 has a fastening device 59 for securing an electrode 7 releasably to attachment 50, and for enabling orientation of electrode 7 with respect to its longitudinal axis of symmetry. More specifically, ends 58 of electrodes 7 have respective radially outer fastening portions 60 which rest on respective peripheral edges of seats 57 to secure electrodes 7 axially inside respective seats 57. In the non-limiting example shown, fastening portions 60 are defined by nuts which engage respective threaded rods at ends 58 of electrodes 7, and which, once electrodes 7 are installed, rest on a top face of plate 51b.

One of electrodes 7 has a known electric connector 61, and current is supplied to the other electrodes by plate 51b (if made of conducting material) or by a further connecting member (not shown).

Both tube 55 and electrodes 7 project downwards to a given distance from cap 12; tube 55, which is open at the bottom, defines a feed portion of a channel 62 for circulating dialysis liquid inside cell 1; and, on reaching the bottom of tube 55, the dialysis liquid flows back up inside the annular gap defined by tube 55 and membrane 9, and out through outlet fitting 35.

The number and type of electrodes 7 in cell 1 can be varied selectively as required by specific applications. In fact, only the electrodes 7 required for a given performance are installed in cell 1, by simply inserting them inside respective seats 57 and connecting them to electric connector 61. Tubular electrodes may be used instead of solid-bar electrodes 7.

FIG. 5 shows a version of cell 1 which, in this case, as opposed to a number of solid-bar electrodes 7, houses a single tubular electrode 7b defined by a straight hollow cylinder extending along axis A and housed coaxially inside body 13. Electrode-holder member 51 is replaced by a different electrode-holder member 65 comprising an end portion 66 of electrode 7b and having three radially outer fastening members 52 defined, for example, by respective bolts, which screw onto the lateral wall of electrode 7b, and are positioned to correspond with and for axial insertion inside connecting seats 28 to support electrode 7b inside body 13. End 66 also carries electric connector 61.

Connecting portion 26 of supporting structure 8 may alternatively receive electrode-holder members 51 and 65 or other types of electrode-holder members in general, so that cell 1 can be fitted alternatively with a single tubular electrode 7b, or with a number of solid-bar electrodes 7 arranged about axis A and supported by plate 51b.

FIG. 5 also shows, by way of example, a variation of outlet fitting 35.

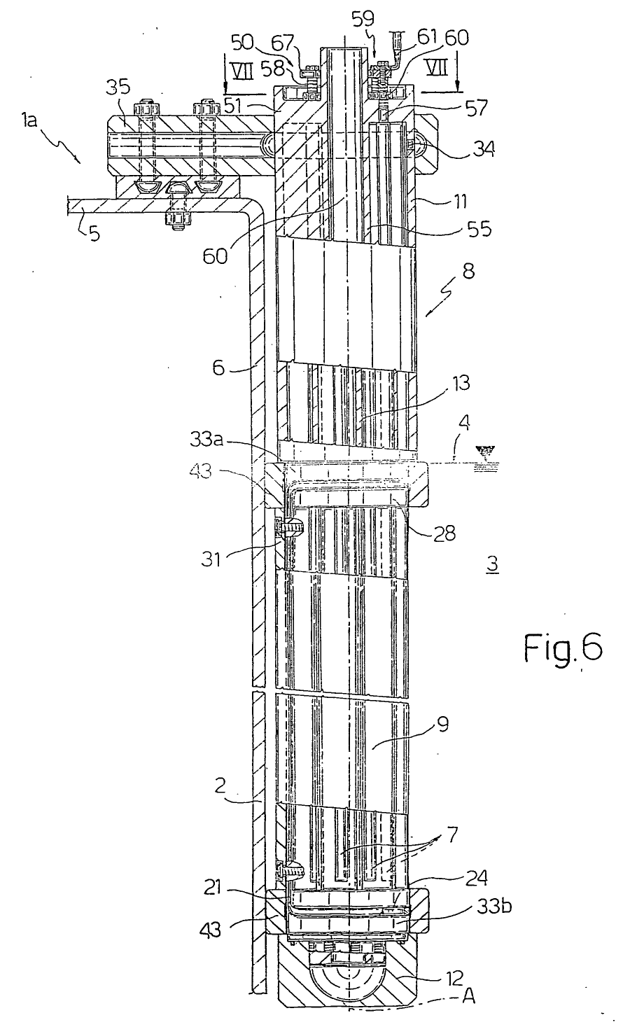

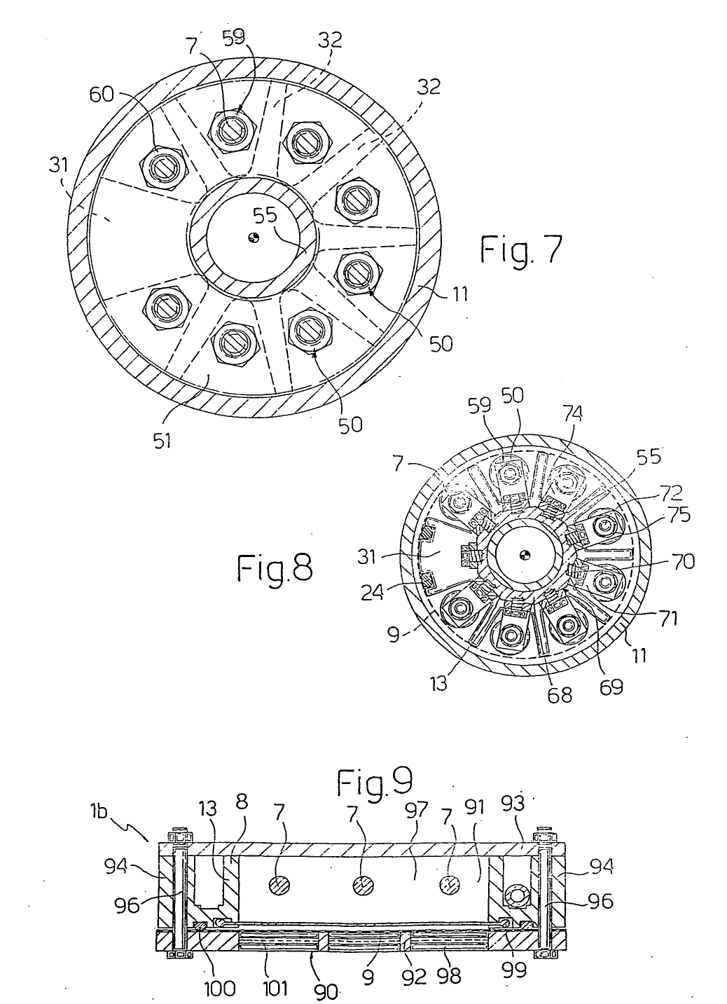

FIGS. 6 and 7—in which any details similar to or identical with those already described are indicated using the same reference numbers—show a variation la of the cell according to the invention, and which comprises a different body 13. In this case, body 13, defined for example by an extruded section of rigid polymer material, comprises a circular-section central tube 55 having a straight axis (coincident with axis A) and integrally supporting a solid longitudinal rib 31 parallel to tube 55, and a number of longitudinal arms 32 also parallel to tube 55. Rib 31 and arms 32 extend longitudinally along a predetermined portion of tube 55; and arms 32 are arranged radially about tube 55, are spaced circumferentially apart, and project radially from tube 55 to define a number of seats for respective electrodes 7.

Body 13 also comprises two collars 33a, 33b axially apart, fitted radially outwards about arms 32, and connected to each other by rib 31. The top collar 33a is connected to a cylindrical tubular portion coaxial with tube 55 and defining head 11; and cap 12 is fitted in fluidtight manner to bottom collar 33b.

Membrane 9 is fitted to body 13 by a fastening system identical with the one already described. That is, a continuous groove 21 is provided housing a seal 24 and comprising two circumferential portions (formed in respective lateral surfaces of collars 33a, 33b) and two axial portions (connecting the circumferential portions and formed in the radially outer lateral surface of rib 31 on the opposite side to tube 55).

Membrane 9, again defined by a substantially rectangular sheet of semipermeable material, is wound about body 13 in a closed polygonal configuration, by being stretched over the free ends of arms 32, and is gripped to body 13, with the interposition of seal 24, by two fastening rings 43 fitted about collars 33a, 33b, and by a fastening bar 47.

Cell 1a comprises an electrode-holder member 51 integral in one piece with body 13, and which is in the form of a transverse disk-shaped plate closing the open top end of head 11 and fitted through centrally with tube 55. In this case too, electrode-holder member 51 comprises a number of attachments 50 for supporting respective electrodes 7—defined by 25 respective straight, circular-section, solid cylindrical bars—in respective given positions—in particular, about central axis A of cell 1a.

In this case too, attachments 50 are defined by respective seats 57 formed through electrode-holder member 51, parallel to and about axis A, and in which respective axial ends 58 of electrodes 7 are inserted. The fastening devices 59 for fastening electrodes 7 to the respective attachments are identical with those already described: ends 58 of electrodes 7 have respective radial fastening portions 60 (e.g. defined by nuts screwed to respective threaded rods) which, when electrodes 7 are installed, rest on the top face of electrode-holder member 51 and on respective peripheral edges of seats 57.

To supply electrodes 7, an annular connecting plate 67 with electric connector 61 is provided over electrode-holder member 51 to connect electrodes 7, is in turn provided, for example, with through holes for the insertion of electrodes 7, and is bolted to electrodes 7.

The FIG. 8 variation differs from the one in FIGS. 6 and 7 solely as regards the configuration of attachments 50: the top end of tube 55 supports an integral, e.g. polygonal, radially outer disk 68 having a number of lateral faces 69 fitted, e.g. by means of screws 70, with respective L-shaped brackets 71, from which are suspended respective electrodes 7. For example, electrodes 7 have respective threaded end rods 72 inserted through respective seats in the free arms 74 of brackets 71, and engaged by respective nuts 75.

Disk 68 also provides for supplying electrodes 7, for which purpose it is provided with an electric connector (not shown but identical with the one already described and illustrated).

FIGS. 9 and 10—in which any details similar to or identical with those already described are indicated using the same reference numbers—show two versions of a further variation 1b of the electrodeposition and electrodialysis cell according to the invention. Cell 1b is a flat cell, i.e. having a semipermeable membrane 9 arranged substantially flat along the front 90 of cell 1b. As stated, in this context, the term “flat cell” includes any cell in which the membrane is open and arranged along the front of the cell, which may be flat or curved, e.g. parabolic.

Cell 1b also comprises a rigid supporting structure 8 fitted with membrane 9 and defining, together with membrane 9, a channel for circulating a dialysis liquid inside cell 1b. In the example shown, supporting structure 8 comprises a rigid, substantially prismatic body 13 having an inner chamber 91. Body 13 comprises a front wall 92, defining front 90 of cell 1b, a rear wall 93, and two lateral walls 94 assembled to one another, for example, by means of bolts 96, a bottom wall 97; and a cover parallel to bottom wall 97, and therefore to the FIG. 9 plane, and not shown for the sake of simplicity.

Through windows 98 are formed in front wall 92; membrane 9 is arranged parallel to front wall 92 to cover windows 98, and is fitted in known manner to body 13, e.g. supported by wires 99; a seal 100 extends along a peripheral edge of membrane 9; and front wall 92 has a safety grille 101 on the outside of membrane 9.

Cell 1b is also designed to house a selected number of electrodes 7 in respective given positions inside chamber 91. Like cells 1 and 1a, therefore, supporting structure 8 is fitted with an electrode-holder member defined, for example, by a plate of the cover of cell 1b, and having a number of attachments for respective electrodes 7; each attachment having a fastening device for fastening an electrode releasably to the attachment.

In this case, the attachments for electrodes 7 are aligned parallel to front 90 of the cell (i.e. to membrane 9); and the electrodes 7 selected for installation in cell 1b are arranged, in use, parallel, substantially coplanar with one another, and side by side along front 90 of cell 1b. The attachments may be arranged otherwise than as shown herein by way of example, e.g. may be arranged in an arc, so that the respective electrodes are arranged, use, along a curved surface.

In the FIG. 9 version, cell 1b is fitted with electrodes 7 defined by respective straight, circular-section, solid cylindrical bars, and, in the FIG. 10 version, is fitted with tubular electrodes 7b. Besides housing a selected number of electrodes, cell 1b may therefore be fitted alternatively with different types of electrodes, e.g. defined by solid bars or by tubular members.

Clearly, changes may be made to the electrodeposition and electrodialysis cell as described and illustrated herein without, however, departing from the scope of the present invention.

1) An electrodeposition and electrodialysis cell (1; 1a; 1b) comprising a supporting structure (8); at least one electrode (7); and a semipermeable membrane (9) surrounding the electrode,, at a given distance from the electrode, and defining, together with the supporting structure, a channel (62) in which to circulate a dialysis liquid inside the cell; the cell being characterized by comprising supporting means (10) for supporting a selected number of electrodes (7), so as to selectively vary the number and type of electrodes in the cell.

2) A cell as claimed in claim 1, characterized in that said supporting means (10) comprise a first electrode-holder member (51) carried by the supporting structure (8) and having a number of attachments (50), each for supporting a respective electrode (7).

3) A cell as claimed in claim 2, characterized in that said attachments (50) are associated with respective fastening devices (59) for securing said electrodes (7) releasably to the respective attachments (50).

4) A cell as claimed in claim 3, characterized in that said fastening devices (59) are such as to enable each electrode (7) to be oriented with respect to its longitudinal axis of symmetry.

5) A cell as claimed in claim 4, characterized in that each of said attachments (50) is defined by a seat (57) in which one end (58) of a respective electrode (7) is insertable; said end (58) having a fastening portion (60) which rests on a peripheral edge of the seat (57) to secure the electrode (7) axially inside the seat (57).

6) A cell as claimed in one of claims 2 to 5, characterized in that said electrodes (7) are defined by solid bars.

7) A cell as claimed in claim 6, characterized in that said electrodes (7) are defined by straight, circular-section, solid cylindrical bars.

8) A cell as claimed in one of claims 2 to 7, characterized in that said attachments (50) are designed to alternatively receive respective electrodes (7) defined by solid bars, and respective tubular electrodes (7b).

9) A cell as claimed in one of claims 2 to 8, characterized by being a flat cell (1b); said first electrode-holder member being a plate on which said attachments (50) are arranged substantially aligned with one another parallel to the front (90) of the cell; and said electrodes (7) being arranged substantially parallel to one another and side by side along said front (90) of the cell.

10) A cell as claimed in one of claims 2 to 8, by being a tubular cell (1; 1a); said first electrode-holder member (51) comprising a disk-shaped plate (51a) on which said attachments (50) are arranged substantially about a central axis (A) of the cell; and the electrodes (7) being arranged parallel to one another about said axis (A).

11) A cell as claimed in claim 9 or 10, characterized in that said first electrode-holder member (51) is integral in one piece with the supporting structure (8).

12) A cell as claimed in claim 9 or 10, characterized in that said first electrode-holder member (51) is connectable releasably to the supporting structure (8) to permit replacement by a second electrode-holder member (65) of a different type.

13) A cell as claimed in claim 12, characterized in that the supporting structure (8) has a connecting portion (26) for alternatively receiving said electrode-holder members (51, 65); the connecting portion (26) having connecting seats (28) for the insertion of respective fastening members (52) carried by the electrode-holder members.

14) A cell as claimed in claim 13, characterized in that the connecting portion (26) comprises a substantially annular end edge (27) having three connecting seats (28) spaced circumferentially apart; said electrode-holder members (51, 65) having respective sets of three fastening members (52) projecting radially from said electrode-holder members (51, 65) and insertable axially inside said connecting seats (28).

15) A cell as claimed in claim 13 or 14, characterized in that the second electrode-holder member (65) comprises an end portion (66) of a tubular electrode (7b); said end portion (66) having said fastening members (52).
